(19) United States
(12) Patent Application Publication
(10) Pub. No.: US 2022/0172875 A1
(43) Pub. Date: Jun. 2, 2022

(54) MAGNETIC RIBBON AND MAGNETIC CORE USING SAME

(71) Applicants: KABUSHIKI KAISHA TOSHIBA, Tokyo (JP); TOSHIBA MATERIALS CO., LTD., Yokohama-shi (JP)

(72) Inventors: Tadao SAITO, Yokohama Kanagawa (JP); Takahiro MAEDA, Yokohama Kanagawa (JP); Satoru HABU, Yokohama Kanagawa (JP)

(73) Assignees: KABUSHIKI KAISHA TOSHIBA, Tokyo (JP); TOSHIBA MATERIALS CO., LTD., Yokohama-shi (JP)

(21) Appl. No.: 17/677,343

(22) Filed: Feb. 22, 2022

Related U.S. Application Data
(63) Continuation of application No. PCT/JP2020/034201, filed on Sep. 9, 2020.

(30) Foreign Application Priority Data
Sep. 10, 2019 (JP) 2019-164598

(51) Int. Cl. H01F 27/25; H01F 1/153

(52) U.S. Cl. CPC H01F 27/25; H01F 1/15333

(57) ABSTRACT

A magnetic ribbon according to an embodiment has a crystallinity degree of 0.05 or higher and 0.4 or lower when the magnetic ribbon is subjected to XRD analysis, the magnetic ribbon being Fe—Nb—Cu—Si—B-base, and the crystallinity degree being expressed by “a peak total area of a crystalline phase”/(“a peak area of an amorphous phase”+“the peak total area of the crystalline phase”). Also, the magnetic ribbon is preferred to have a region in which a KIKUCHI pattern is detected when the crystalline phase is subjected to EBSD analysis. Also, the thickness of the magnetic ribbon is preferred to be 25 μm or less.

### CROSS-REFERENCE TO RELATED APPLICATIONS

This application is a national stage application of International Application No. PCT/JP2020/034201, filed Sep. 9, 2020, which designates the United States, incorporated herein by reference, and which claims the benefit of priority from Japanese Patent Application No. 2019-164598, filed Sep. 10, 2019, the entire contents of which are incorporated herein by reference.

### FIELD

An embodiment basically relates to a magnetic ribbon and a magnetic core using same.

### BACKGROUND

A noise filter, which is a combination of an inductance part and a capacitor part, is used for input/output of an electric power conversion device such as a switching regulator. This inductance part employs a common-mode choke coil for removing common-mode noise. A common-mode choke coil is a coil wound around a magnetic core.

Examples of a magnetic material used in the magnetic core include ferrite, an amorphous alloy, and a Fe-based microcrystal material. Among these, the Fe-based microcrystal material has become common from a viewpoint of reduction in size and weight. The Fe-based fine crystal material is a material obtained by subjecting a Fe-based amorphous alloy containing Cu to heat treatment at a crystallization temperature or higher. When the Fe-based microcrystal material is used, an inductance value of a part can be enhanced since a high magnetic permeability is achieved, and reduction in size and weight can be therefore achieved. Since the Fe-based microcrystal material has a high magnetic flux density and a low loss, the material is used mainly for a use that requires a high-voltage-pulse attenuating ability or a use for high currents.

For example, WO 2018/062409 A discloses a magnetic core having a magnetic permeability of 25000 or higher at a frequency of 100 kHz. The above Patent Literature also discloses a magnetic core around which an iron-base soft-magnetic alloy sheet, which has a crystalline structure having an average crystal grain size of 100 nm or lower, is wound. In the above Patent Literature, magnetic permeability has been improved by controlling, for example, the thickness of an insulating layer. Thus, in the above Patent Literature, a space factor of a magnetic ribbon is improved by controlling the insulating layer to improve magnetic permeability.

On the other hand, the Radio Act determines that an application has to be made for an installation permission for a facility that uses a high-frequency current of 10 kHz or higher. The Radio Act also determines installation conditions, etc. Downsizing of an electric power conversion device is effective for satisfying the installation conditions. Electric power conversion devices within a range of 100 kHz to 1 MHz are mainly used. Therefore, a magnetic core which can realize downsizing of the electric power conversion device within a range of 10 kHz or higher, furthermore, a range of 100 kHz to 1 MHz has been desired.

Achieving a high magnetic permeability is effective for achieving downsizing of the magnetic core. The magnetic core of the above Patent Literature has a fairly good magnetic permeability, but there has been a limit for achieving a high magnetic permeability. There has been a limit for achieving a high magnetic permeability particularly within a range of 10 kHz or higher, furthermore, a range of 100 kHz to 1 MHz. A cause thereof was studied, and it was found out that the abundance of a crystalline phase in a Fe-base amorphous alloy ribbon before heat treatment is important.

When a Fe-base fine crystal alloy ribbon is to be manufactured, a Fe-base amorphous alloy ribbon is subjected to heat treatment and crystallized. The Fe-base amorphous alloy ribbon before the heat treatment is in a state in which there is substantially no crystal. It has been found out that a method of subjecting an amorphous alloy, which substantially has no crystal, to heat treatment has a limit for achieving a high magnetic permeability.

As one aspect, the present invention is a measure for such a problem, and it is an object of the present invention to provide a magnetic ribbon which enables achievement of a high magnetic permeability.

### BRIEF DESCRIPTION OF DRAWINGS

FIG. 1 is a drawing illustrating an example of a magnetic ribbon according to an embodiment.

FIG. 2 is a drawing illustrating an example of a magnetic core according to the embodiment.

FIG. 3 is a drawing illustrating another example of the magnetic core according to the embodiment.

### DETAILED DESCRIPTION

A magnetic ribbon according to an embodiment has a crystallinity degree of 0.05 or higher and 0.4 or lower when the magnetic ribbon is subjected to XRD analysis, the magnetic ribbon being Fe—Nb—Cu—Si—B-base, and the crystallinity degree being expressed by “a peak total area of a crystalline phase”/(“a peak area of an amorphous phase”+“the peak total area of the crystalline phase”).

The Fe—Nb—Cu—Si—B-base is an iron alloy containing iron (Fe), niobium (Nb), copper (Cu), silicon (Si), and boron (B) as constituent elements.

A composition of the iron alloy is expressed, for example, by a following general formula (composition formula).

FeₐCu_{b}Nb_{c}M_{d}SiₑB_{f} General formula

The number that satisfies a+b+c+d+e+f=100 atomic % is represented by a, the number that satisfies 0.01≤b≤8 atomic % is represented by b, the number that satisfies 0.01≤c≤10 atomic % is represented by c, the number that satisfies 0≤d≤20 atomic % is represented by d, the number that satisfies 10≤e≤25 atomic % is represented by e, and the number that satisfies 3≤f≤12 atomic % is represented by f. Also, in the formula, M is at least one element selected from a group consisting of Group 4 elements, Group 5 elements (except Nb), Group 6 elements, and rare-earth elements of the periodic table.

Iron (Fe) is an element which constitutes a crystalline phase with silicon (Si). The price of the material becomes inexpensive when Fe is contained as a main component.

Copper (Cu) is effective for enhancing corrosion resistance, preventing coarsening of crystal grains, and improving soft magnetic properties such as iron loss and magnetic permeability. The content of Cu is preferred to be 0.01 atomic % or higher and 8 atomic % or lower (0.01≤b≤8). If the content is less than 0.01 atomic %, the effects of added copper are low. If the content exceeds 8 atomic %, magnetic properties are lowered.

Niobium (Nb) is effective for homogenization of crystal grain sizes and stabilization of magnetic properties with respect to temperature changes. The content of the element M is preferred to be 0.01 atomic % or higher and 10 atomic % or lower (0.01≤c≤10).

Silicon (Si) and boron (B) facilitate causing an alloy to be amorphous or precipitation of microcrystals in manufacturing. Si and B are effective for the heat treatment for improving the crystallization temperature and magnetic properties. Particularly, Si becomes a solid solution in Fe, which is a main component of the fine crystal grains, and is effective for reducing magnetostriction and magnetic anisotropy. The content of Si is preferred to be 10 atomic % or higher and 25 atomic % or lower (10≤e≤25). The content of B is preferred to be 3 atomic % or higher and 12 atomic % or lower (3≤f≤12).

M is at least one element selected from a group consisting of Group 4 elements, Group 5 elements (except Nb), Group 6 elements, and rare-earth elements of the periodic table. Examples of Group 4 elements include Ti (titanium), Zr (zirconium), and Hf (hafnium). Examples of Group 5 elements include V (vanadium) and Ta (tantalum). Examples of Group 6 elements include Cr (chromium), Mo (molybdenum), and W (tungsten). Examples of the rare-earth elements include Y (yttrium), lanthanoid elements, and actinoid elements. The M element is effective for homogenization of crystal grain sizes and stabilization of magnetic properties with respect to temperature changes. The content of the element M is preferred to be 0 atomic % or higher and 20 atomic % or lower (0≤d≤20).

As the general formula, a formula including Fe, Nb, Cu, Si, and B (d=0 atomic %) is preferred. When the above described general formula is satisfied, a Fe₃Si phase is formed. The Fe₃Si phase is a type of an α′-Fe phase. The α′-Fe phase is included in an α-Fe phase in a broad sense. The fine crystal grains have at least one phase selected from a group mainly consisting of an α-Fe phase, a Fe₃Si phase, and a Fe₂B phase. Each crystal may contain the constituent elements that satisfy the general formula.

Also, as a magnetic ribbon, a casted long ribbon or a long ribbon cut into a predetermined size is represented. The long ribbon cut into a predetermined size may have an arbitrary size.

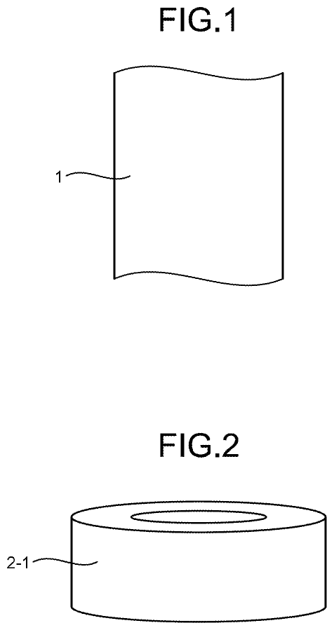

Also, a magnetic ribbon according to the embodiment has a crystallinity degree of 0.1 or higher and 0.4 or lower when the magnetic ribbon is subjected to XRD analysis (X-ray Diffraction), the crystallinity degree expressed by “a peak total area of a crystalline phase”/(“a peak area of an amorphous phase”+“the peak total area of the crystalline phase”). FIG. 1 illustrates an example of the magnetic ribbon. In the drawing, the magnetic ribbon is denoted by 1.

First, XRD analysis conditions will be described. XRD analysis is carried out under conditions of a Cu target, a tube voltage of 40 kV, a tube current of 40 mA, and a slit width (RS) of 0.40 mm. Also, a measurement condition is set to Out of Plane (θ/2θ), and a range in which a diffraction angle 2θ is 5° to 140° is subjected to measurement.

A peak that has a strongest peak at a diffraction angle (2θ) of 30° to 60° and has a half width of 3° or higher is assumed to be a peak of an amorphous phase. The area of the above mentioned peak of the amorphous phase assumed to be a peak area of the amorphous phase. All peaks except for the peak of the amorphous phase detected at 5° to 140° are assumed to be the peaks of crystalline phases. A total area of the above mentioned peaks of the crystalline phases is assumed to be a peak total area of the crystalline phases.

According to the above described XRD analysis conditions, the peaks of the amorphous phases are detected at 22°±1° and 44°±1°. In other words, the peaks other than these are counted as the peaks of crystalline phases.

Crystallinity degree=“the peak total area of the crystalline phases”/(“the peak area of the amorphous phases”+“the peak total area of the crystalline phases”) A crystallinity degree of 0.05 or higher and 0.4 or lower means that a predetermined amount of crystalline phases are present in the magnetic ribbon. As described later, a fine crystalline structure is formed by subjecting a magnetic core around which a magnetic ribbon is wound to heat treatment. Therefore, it means that the crystallinity degree of the magnetic core (or the magnetic ribbon) before carrying out the heat treatment for forming the fine crystalline structure is 0.05 or higher and 0.4 or lower. Also, it means that crystalline phases are present in the casted magnetic ribbon since the above described magnetic core corresponds to a magnetic core (or magnetic ribbon) before carrying out heat treatment for forming fine crystalline structures.

The fine crystal grains have at least one crystalline phase selected from a group mainly consisting of an α-Fe phase, a Fe₃Si phase, and a Fe₂B phase. It is preferred that these crystalline phase(s) be formed in the casted magnetic ribbon. When the crystalline phases are formed in the casted magnetic ribbon, the originally-present crystalline phases serve as nuclei during heat treatment, and fine crystalline structures can be formed. As a result, achievement of a high magnetic permeability can be realized.

Also, if the crystallinity degree is less than 0.05, the effect of forming the crystalline phases low. Also, if the crystallinity degree exceeds 0.4, it may become difficult to cause crystals to be fine. Also, the risk of damage caused upon winding around the core becomes high. Therefore, the crystallinity degree is preferably within a range of 0.05 or higher and 0.4 or lower, more preferably within a range of 0.05 or higher and 0.3 or lower, and further preferably within a range of 0.1 or higher and 0.3 or lower. When the crystallinity degree is 0.3 or lower, the strength of the magnetic ribbon is improved. When the crystallinity degree is 0.1 or higher, crystallinity is stabilized. Also, the magnetic ribbon according to the embodiment has the crystallinity degree within the range of 0.05 or higher and 0.4 or lower, for example, even when any of a ribbon surface is subjected to XRD analysis.

Also, when the crystalline phases are subjected to EBSD analysis, a region in which a KIKUCHI pattern is detected is preferably present. The EBSD analysis refers to an electron backscatter diffraction pattern method. In EBSD analysis, analysis of crystal orientations can be carried out. KIKUCHI patterns (KIKUCHI images) are lines or bands observed other than diffraction spots. They are also referred to as KIKUCHI figures. A KIKUCHI pattern is a figure generated when incident electrons cause Bragg reflection after undergoing inelastic scattering caused by thermal vibrations of atoms in crystals.

Regarding bright/dark lines of the KIKUCHI pattern, the lines close to the direction of incident rays are dark, and the lines distant therefrom are bright. The higher the crystallinity, the brighter the line appears. By virtue of this, growth directions of crystals can be also determined. Therefore, generally, detection of a KIKUCHI pattern means presence of crystal orientations <111>, <120>, <110>, etc.

Presence of a region in which a KIKUCHI pattern is detected means presence of crystalline phases. Fine crystalline structures can be formed by heat treatment while using the crystalline phases as nuclei. Therefore, it is preferred that a region in which a KIKUCHI pattern is detected is found in measurement of any location of the crystalline phases of the magnetic ribbon.

Note that, in the EBSD analysis, an electron beam condition was set to 15 kV to carry out evaluation. For an EBSD analysis apparatus, Hikari High Speed EBSD Detector OIM analysis software ver. 7 produced by EDAX (TSL) was used. The number of measurement view fields was five or more. If a KIKUCHI pattern is detected within five times, measurement may be stopped.

Also, a sheet thickness of the magnetic ribbon is preferred to be 25 μm or lower. An eddy-current loss can be reduced by reducing the sheet thickness of the magnetic ribbon. Therefore, the sheet thickness of the magnetic ribbon is preferred to be lower than 25 μm or lower and is more preferred to be 20 μm or lower. Note that the sheet thickness of the magnetic ribbon is an average sheet thickness. The average sheet thickness is obtained by an average value of the thicknesses at arbitrary five locations obtained by observing cross sections of the magnetic ribbon by using micro measurement equipment.

Surface roughness Ra of the magnetic ribbon is preferred to be 1.0 μm or lower. Low surface roughness Ra enables suppression of damage of the magnetic ribbon which is caused upon winding. Also, the thickness of an insulating layer of interlayer insulation of the magnetic core can be uniformized. Also, formation of gaps between the insulating layer and the magnetic ribbon can be suppressed. Therefore, the space factor can be improved.

When areas of crystalline phases of a surface portion and a center portion of the magnetic ribbon are compared, it is preferred that the surface portion has more crystalline phases. Herein, the crystalline phases are only required to be present in either one of the surface portions of the magnetic ribbon. The surface portion is a region within 2 μm from a concave portion of the surface of the magnetic ribbon. The center portion is a region whose range is within ±2 μm from a thickness-direction center of the magnetic ribbon. The concave portion of the surface is a portion which is concaved the most among surface concave convex portions of a measurement area. The crystalline phase is a phase mainly composed of one or more species selected from among an α-Fe phase, a Fe₃Si phase, and a Fe₂B phase. When the surface portion of the magnetic ribbon has a large amount of the crystalline phase, fine crystals can be obtained by later-described crystallization heat treatment. By virtue of this, magnetic properties can be improved. Also, it is preferred that the center portion of the magnetic ribbon does not have the crystalline phase. The area ratios of the crystalline phases in the surface portion and the center portion can be found out by subjecting cross sections of the magnetic ribbon to EBSD analysis.

A magnetic core is obtained by winding or stacking the magnetic ribbon as described above. The magnetic ribbon is wound or stacked after processed into a required size. Also, interlayer insulation is carried out in accordance with needs.

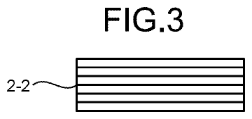

FIG. 2 and FIG. 3 illustrate examples of the magnetic core. FIG. 2 illustrates an example of a winding-type core. Also, FIG. 3 illustrates an example of a stacking-type magnetic core. In the drawings, the winding-type magnetic core is denoted by 2-1, and the stacking-type magnetic core is denoted by 2-2.

The winding-type magnetic core 2-1 is a wound magnetic ribbon 1. The winding-type magnetic core 2-1 has a donut-like shape having a hollow center. Also, an insulating layer may be provided on a surface of the magnetic ribbon 1. FIG. 2 illustrates a circular one as an example. However, a magnetic core wound in a tetragonal shape, an elliptical shape, or a U-shape may be used.

The stacking-type magnetic core 2-2 is a stack of the magnetic ribbons 1. The number of the stacked ribbons is arbitrary. Also, an insulating layer may be provided on a surface of the magnetic ribbon 1. Examples of the shape of the magnetic ribbon 1 include various shapes such as a rectangular shape, a square shape, an H-shape, a U-shape, a triangular shape, and a circular shape.

It is preferred to form crystalline structures having an average crystal grain size of 200 nm or lower by carrying out heat treatment after forming the magnetic core. Also, the magnetic core after the heat treatment is preferred to have the value of crystallinity degree of 0.9 or higher. The heat treatment temperature is set to a temperature higher than a first crystallization temperature. The first crystallization temperature is in a vicinity of 500° C. to 520° C.

The crystallization temperature is the temperature at which crystals start precipitating. Crystals can be precipitated by carrying out heat treatment in the vicinity of the crystallization temperature. A Fe—Nb—Cu—Si—B-base magnetic ribbon has the first crystallization temperature and a second crystallization temperature. The first crystallization temperature is in the vicinity of 500° C. to 520° C. The second crystallization temperature is 600° C. or higher. Crystals can be precipitated by carrying out heat treatment in the vicinity of the first crystallization temperature or at a temperature higher than the first crystallization temperature. Crystals can be precipitated by carrying out heat treatment in the vicinity of the second crystallization temperature or at a temperature higher than the second crystallization temperature.

The heat treatment carried out in the vicinity of the first crystallization temperature or at a temperature higher than the first crystallization temperature is referred to as first heat treatment. The heat treatment carried out in the vicinity of the second crystallization temperature or at a temperature higher than the second crystallization temperature is referred to as second heat treatment. The crystallinity degree can be controlled by combining the first heat treatment and the second heat treatment.

The average crystal grain size is obtained by the equation of Scherrer from the half width of the diffraction peak obtained by XRD analysis. The equation of Scherrer is expressed as D=(K·λ)/(β cos θ). Herein, D represents an average crystal grain size, K represents a shape factor, λ represents an X-ray wavelength, β represents a peak full width at half maximum (FWHM), and θ represents a Bragg angle. The shape factor K is set to 0.9. The Bragg angle is half of the diffraction angle 2θ. Note that conditions of the XRD analysis are the same as the conditions used to measure the above described crystallinity degree.

The average crystal grain size is preferred to be 200 nm or lower and is more preferred to be 50 nm or lower. When the average crystal grain size is small, reduction of iron loss and improvement of magnetic permeability can be achieved.

Also, the crystallinity degree is preferred to be 0.9 or higher and is more preferred to be 0.95 or higher and 1.0 or lower. The higher the crystallinity degree, the higher the percentage of crystals in the magnetic ribbon. In other words, the percentage of crystals is increased by subjecting the magnetic core to heat treatment. Also, after the heat treatment, it is preferred that the average crystal grain size of the magnetic core is configured to be smaller than the average crystal grain size of the magnetic ribbon.

The magnetic core as described above is subjected to insulating treatment such as housing in a resin mold or an insulating case. Also, it is preferred to wind a coil therearound. By winding a coil therearound, a magnetic part such as a choke coil is provided. Also, insulation between the coil and the magnetic core can be achieved by subjecting the magnetic core to insulation treatment. Also, damage of the magnetic core which is caused upon coil winding can be also prevented.

Note that the magnetic cores according to the embodiment include those which have undergone insulating treatment or coil winding.

Achievement of a high magnetic permeability can be realized by the magnetic cores described above. Achievement of a high magnetic permeability particularly in a range of 10 kH or higher, furthermore, a range of 100 kHz to 1 MHz is enabled.

Also, it is preferred that L₁₀/L₁₀₀ is 1.5 or lower and a magnetic permeability at 100 kHz is 15000 or higher, wherein inductance at 10 kHz is L₁₀, and inductance at 100 kHz is L₁₀₀. Also, it is preferred that L₁₀₀/L_{1M} is 11 or lower and a magnetic permeability at 100 kHz is 15000 or higher, wherein inductance at 100 kHz is Liao, and inductance at 1 MHz is Lm.

A state that L₁₀/L₁₀₀ is 1.5 or less means that variations of the inductance value at 10 kHz to 100 kHz are suppressed. Also, a state that L₁₀₀/L_{1M} is 11 or lower means that reduction of the inductance value at 100 kHz to 1 MHz is suppressed. Also, the magnetic permeability at 100 kHz is 15000 or higher.

For example, Table 5 of the above mentioned WO 2018/062409 A shows the magnetic permeability at 10 kHz and 100 kHz. According to Table 5 of the Patent Literature, when the frequency increases, the magnetic permeability becomes about half. In this manner, the higher the magnetic permeability a conventional microcrystal material has, the lower the magnetic permeability thereof. The same applies also to the inductance value. In order to take a measure against this, increasing the number of winding of the coil or the size of the magnetic core is required. On the other hand, when a measure is taken by increasing the number of winding or a large core size, there has been a problem that hunting, etc. caused by increase of inductance become large in a low-frequency side of 100 kHz or lower.

The magnetic core according to the embodiment can suppress variations in the inductance value and the magnetic permeability at 10 kHz or higher and 1 MHz or lower. Therefore, the magnetic core with a high magnetic permeability can be stably provided within the range of 10 kHz or higher and 1 MHz or lower. In other words, the frequency dependency of the magnetic core is improved. Note that the magnetic core according to the embodiment may be used in a range exceeding 1 MHz.

Also, a lower limit value of L₁₀/L₁₀₀ is not particularly limited, but is preferred to be 1.1. or higher. Also, the lower limit value of L₁₀₀/L_{1M} is not particularly limited, but is preferred to be 6 or higher. If L₁₀/L₁₀₀ or L₁₀₀/L_{1M} is too small, the magnetic permeability may become too low.

A measurement method of the inductance value and the magnetic permeability is carried out with an impedance analyzer (Hewlett-Packard Japan Inc., YHP4192A) at a room temperature, 1 turn, and 1 V. Regarding the magnetic permeability, the magnetic permeability is obtained from the inductance values of frequencies of 10 kHz, 100 kHz, and 1 MHz.

The magnetic core according to the embodiment can increase an AL value. The AL value satisfies a relation of an equation: “AL value”∝μ×Ae/Le. The magnetic permeability is represented by μ, an average magnetic path length is represented by Le, and an effective cross-sectional area is represented by Ae. The AL value is an index indicating performance of the magnetic core. It means that the higher the AL value, the higher the inductance value.

In a case in which the sizes (Ae/Le) of the magnetic cores are the same, the higher the magnetic permeability μ, the higher the AL value. When the average magnetic path length Le is increased, the AL value becomes lower. When the effective cross-sectional area Ae is reduced, the AL value becomes lower.

When the size of the magnetic core is enlarged, the AL value becomes higher. On the other hand, increase in the size of the magnetic core causes a problem of disposition space in electronic equipment. In the magnetic core according to the embodiment, the frequency dependency of the inductance value and the magnetic permeability μ is suppressed. By virtue of this, the average magnetic path length Le of the magnetic core can be reduced. The improvement of the AL value enables downsizing of the magnetic core. By virtue of this, the weight of the magnetic core is reduced, and disposition space in electronic equipment can be readily ensured. Therefore, the degree of freedom of design in the electronic equipment can be improved.

When the magnetic core is downsized, cost can be also lowered since the required amount of the magnetic ribbon constituting the magnetic core is lower. Even when the number of winding is reduced, equivalent properties can be obtained. Since the usage amount of winding can be reduced by reducing the number of times of winding, cost can be reduced. Furthermore, the probability of damaging the magnetic core during a winding process can be lowered by reducing the number of times of winding. Therefore, yield in the winding process can be improved. Also, when the number of times of winding is reduced, the amount of heat generation of winding can be reduced.

Downsizing of the magnetic core also leads to reduction in weight. More specifically, if the properties of the magnetic core are equivalent to a conventional magnetic core, reduction in size and weight is realized. The reduction in size and weight of the magnetic core leads to reduction in size and weight of electronic equipment such as a switching power supply, an antenna device, and an inverter. Also, as described above, in the magnetic core according to the embodiment, the amount of heat generation can be suppressed. Therefore, this is suitable for a field in which temperature changes in a usage environment are large or a high current field (20 amperes or higher). Examples of such fields include solar light inverters, EV-motor-driving inverters, etc.

Next, a manufacturing method of the magnetic ribbon according to the embodiment will be described. As long as the magnetic ribbon according to the embodiment has the above described structure, the manufacturing method thereof is not particularly limited. However, methods for obtaining a high yield include a following method.

First, a process of manufacturing a magnetic ribbon is carried out. First, raw powder which is a mixture of constituent components is prepared so as to satisfy the above described general formula (composition formula). Next, this raw powder is dissolved to prepare raw molten metal. A long magnetic ribbon is manufactured by using the raw molten metal by a roll rapid-cooling method. The roll rapid-cooling method is a method of ejecting the raw molten metal onto a cooling roll, which rotates at high speed. When the roll rapid-cooling method is carried out, it is preferred to set a surface roughness Ra of the cooling roll to 1 μm or less.

Also, when the roll rapid-cooling method is carried out, it is preferred to clean the roll surface. By cleaning the roll surface, the manner of contact between the cooling roll and the raw molten metal can be stabilized. For example, a preferred method uses about half the perimeter of the cooling roll as the contact surface of the raw molten metal and cleans the surface, which is not in contact with the raw molten metal, during rotation of the cooling roll. By cleaning the cooling roll during rotation, the manner of contact between the cooling roll and the raw molten metal can be stabilized. Examples of the method of cleaning include pressing of a brush, pressing of cotton (cotton cloth), and gas jetting.

By carrying out this, cooling efficiency is improved, and the crystallinity degree can be controlled. Therefore, the magnetic ribbon having a crystallinity degree of 0.05 or higher and 0.4 or lower can be manufactured. Also, the surface roughness Ra can be configured to be 1 μm or lower.

Also, if the crystallinity degree of the magnetic ribbon after the roll rapid-cooling method is less than 0.05, a method of adjusting the crystallinity degree may be carried out by laser treatment.

The magnetic ribbon according to the embodiment can be obtained by this process. Next, a manufacturing method of the magnetic core will be described.

A process of providing an insulating layer on the obtained magnetic ribbon is carried out. As the magnetic ribbon, a magnetic ribbon processed into a target size may be used, or the insulating layer may be provided on a long ribbon.

Next, a process of manufacturing a magnetic core is carried out. In a case of a winding-type magnetic core, a long magnetic ribbon provided with an insulating layer is wound for manufacturing. An outermost periphery of the winding is fixed by spot welding or an adhesive agent.

In a case of a stacking-type magnetic core, examples include a method of stacking a long magnetic ribbon provided with an insulating layer and then cutting the ribbon into a required size. Also, a long magnetic ribbon provided with an insulating layer may be cut into a required size and then stacked. A lateral surface of a stack is fixed with an adhesive agent. It is preferred to coat the surface of the magnetic core with a resin. The strength of the magnetic core can be improved by the resin coating.

Then, the magnetic core is subjected to heat treatment to precipitate fine crystals and form fine crystalline structures. Since the magnetic ribbon becomes brittle as a result of the precipitation of fine crystals, it is preferred to carry out the heat treatment after forming into a state of the magnetic core.

A heat treatment temperature is preferred to be a temperature close to the crystallization temperature (first crystallization temperature) or a temperature higher than that. Herein, a temperature higher than −20° C. of the crystallization temperature is preferred. If the magnetic ribbon is an iron-base soft-magnetic alloy sheet which satisfies the above described general formula, the crystallization temperature is 500° C. or higher and 520° C. or lower. Therefore, the heat treatment temperature is preferred to be 480° C. or higher and 600° C. or lower. The heat treatment temperature is more preferred to be 510° C. or higher and 560° C. or lower. The heat treatment at the temperature close to the first crystallization temperature or the temperature higher than that is referred to as first heat treatment.

Heat treatment time is preferred to be 30 hours or less. The heat treatment time is the time during which the temperature of the magnetic core is 480° C. or higher and 600° C. or lower. If the time exceeds 40 hours, the average grain size of the fine crystal grains sometimes exceeds 200 nm. The heat treatment time is more preferred to be 20 minutes or more and 25 hours or less. The heat treatment time is further preferred to be 1 hour or more and 10 hours or less. Within this range, the average crystal grain size can be readily controlled to 50 nm or lower.

Also, the heat treatment at the temperature close to the second crystallization temperature or the temperature higher than that is referred to as second heat treatment. The second heat treatment temperature is preferred to be 600° C. or higher. The second crystallization temperature is the temperature at which crystallization is facilitated in a temperature region higher than the first crystallization temperature. Crystallization can be further facilitated by carrying out the second heat treatment. More specifically, for example, crystallization of the region which has not been precipitated in the first heat treatment can be carried out. Also, crystals can be further precipitated from the crystals precipitated in the first heat treatment. Therefore, the crystallinity degree can be improved.

Under the above heat treatment conditions, the crystallinity degree of the magnetic core can be caused to be 0.9 or higher. In other words, the crystallinity degree thereof can be caused to be 0.9 or higher, for example, when any location is measured by XRD analysis.

Also, heat treatment in a magnetic field may be carried out in accordance with needs. In the heat treatment in a magnetic field, it is preferred to apply the magnetic field in a short-side direction of the magnetic core. In the winding-type magnetic core, the magnetic field is applied in a width direction. In the stacking-type magnetic core, the magnetic field is applied in a short-side direction of the stack. By carrying out the heat treatment while applying the magnetic field in the short-side direction of the magnetic core, a magnetic wall of the magnetic ribbon can be reduced or removed. The magnetic permeability is improved since loss is reduced when the magnetic wall is reduced. The magnetic field to be applied is preferred to be 80 kA/m or higher and is more preferred to be 100 kA/m or higher. The heat treatment temperature is preferred to be 200° C. or higher and 700° C. or lower. The heat treatment time of the heat treatment in the magnetic field is preferred to be 20 minutes or more and 10 hours or less. The heat treatment in the magnetic field may be carried out as one process together with the above described heat treatment for precipitating fine crystals. In accordance with needs, insulating treatment such as housing the magnetic core in an insulating case is carried out. When mounting on various electronic equipment, a process of winding a coil, in other words, a winding process is carried out in accordance with needs.

### EXAMPLES

### Examples 1 to 3, Comparative Examples 1 to 2, Reference Example 1

Raw powder is prepared so that a ratio (atomic %) of Fe_{73.5}Cu_{1.0}Nb_{3.0}Si_{16.0}B_{6.5} is obtained as a first magnetic ribbon. Raw powder is prepared so that a ratio (atomic %) of Fe_{73.4}Cu_{1.0}Nb_{2.6}Si_{14.0}B_{9.0} is obtained as a second magnetic ribbon. The total value of the atomic % of the components is 100%.

Next, this raw powder was dissolved to prepare raw molten metal. A long magnetic ribbon was manufactured by using the raw molten metal by a roll rapid-cooling method. When the roll rapid-cooling method was carried out, a cooling roll having a surface roughness Ra of 1 μm or less was used.

Also, when the roll rapid-cooling method was carried out, a method of cleaning the cooling roll surface was used in Examples. Meanwhile, in Comparative Example 1, cleaning of the cooling roll surface was not carried out. Also, Comparative Example 2 is an example in which the crystallinity degree was caused to be 0.62 by subjecting the magnetic ribbon of Comparative Example 1 to heat treatment.

The magnetic ribbons according to Examples and Comparative Examples were subjected to measurement of the crystallinity degree.

The measurement of the crystallinity degree was carried out by XRD analysis. XRD analysis was carried out under conditions of a Cu target, a tube voltage of 40 kV, a tube current of 40 mA, and a slit width (RS) of 0.40 mm. A range having a diffraction angle 2θ of 5° to 140° was subjected to the measurement.

A peak that has a strongest peak at a diffraction angle (2θ) of 30° to 60° and has a half width of 3° or higher is assumed to be a peak of an amorphous phase. The area of the peak of the amorphous phase was assumed to be a peak area of the amorphous phase. All peaks except for the peak of the amorphous phase detected at 5° to 140° were assumed to be the peaks of crystalline phases. A total area of the peaks of the crystalline phases was assumed to be a peak total area of the crystalline phases.

The crystallinity degree was obtained by: “the peak total area of the crystalline phases”/(“the peak area of the amorphous phases”+“the peak total area of the crystalline phases”).

Also, the presence/absence of the KIKUCHI pattern was measured by subjecting the crystalline phase to EBSD analysis. In the EBSD analysis, arbitrary three locations were subjected to measurement, the location at which the KIKUCHI pattern was observed at least one time was denoted as “PRESENT”, and the location at which the KIKUCHI pattern was not observed not even one time was denoted as “ABSENT”.

Also, the peak to peak value evaluated by micro measurement equipment was used as the sheet thickness. Arbitrary five locations were subjected to the measurement, and an average value thereof was employed as an average sheet thickness.

Also, an average crystal grain size of crystalline phases was obtained. The average crystal grain size was obtained from the Scherrer equation by carrying out XRD analysis. Also, conditions of the XRD analysis were the same as the conditions used to measure the crystallinity degree.

The results thereof are shown in Table 1.

TABLE 1

| | Magnetic ribbon | | | | | |
|---|---|---|---|---|---|---|
| | Surface | | | | Presence/ | Average |
| | roughness | | Sheet | | absence of | crystal |
| | Ra | | thickness | Crystallinity | KIKUCHI | grain size |
| | (μm) | Composition | (μm) | degree | pattern | (nm) |
| Example 1 | 0.59 | First | 15 | 0.05 | Present | 16 |
| Example 2 | 0.48 | First | 18 | 0.30 | Present | 15 |
| Example 3 | 0.52 | First | 20 | 0.26 | Present | 15 |
| Example 4 | 0.40 | Second | 22 | 0.25 | Present | 18 |
| Example 5 | 0.54 | Second | 18 | 0.15 | Present | 18 |
| Comparative | 2.20 | First | 30 | 0.60 | Absent | 120 |
| example 1 | | | | | | |
| Comparative | 0.44 | First | 22 | 0.62 | Present | 11 |
| example 2 | | | | | | |

Also, presence/absence of crystalline phases of surface portions and center portions was checked regarding cross sections of the magnetic ribbons according to Examples and Comparative Examples. The cross sections of the magnetic ribbons were subjected to EBSD analysis. In the cross sections of the magnetic ribbons, the presence/absence of crystalline phases in the surface portion which is within 2 μm from a concave portion of the surface was checked. Also, the presence/absence of the crystalline phases in the center portion which is in a range of within ±2 μm from the center of the magnetic ribbon was checked. The results are shown in Table 2.

TABLE 2

| | Presence/absence of | Presence/absence of |
|---|---|---|
| | crystalline phase | crystalline phase |
| | in surface portion | in center portion |
| Example 1 | Present | Absent |
| Example 2 | Present | Absent |
| Example 3 | Present | Absent |
| Example 4 | Present | Absent |
| Example 5 | Present | Absent |
| Comparative example 1 | Present | Absent |
| Comparative example 2 | Present | Present |

Magnetic cores were prepared by using the magnetic ribbons according to Examples and Comparative Examples. The magnetic core is a winding-type core having: an outer diameter of 37 mm×an inner diameter of 23 mm×a width of 15 mm. Also, a SiO₂ film was used as interlayer insulation. When the first crystallization temperature of the magnetic ribbon was 509° C. when measured with Differential Scanning Calorimetry (DSC). The second crystallization temperature was 710° C.

Fine crystalline structures were obtained by subjecting the magnetic core to a heat treatment at 530° C. in a nitrogen atmosphere for 1 hour to 10 hours. This heat treatment is the first heat treatment. Then, fine crystalline structures were obtained by subjecting the magnetic core to a heat treatment at 530° C. in atmospheric atmosphere for 1 hour to 10 hours as second heat treatment. Also, Example 1 subjected to heat treatment in atmospheric atmosphere as the second heat treatment was employed as Reference Example 1. As a result of this procedure, magnetic cores according to Examples and Comparative Examples were prepared.

Each of the magnetic cores was subjected to measurement of the crystallinity degree and the average crystal grain size. The measurement method was the same as that of the magnetic ribbons.

Also, the magnetic cores were subjected to measurement of inductance and magnetic permeability. In the measurement of inductance, the magnetic core housed in an insulating case was used. The measurement was carried out with a coil of 1 turn and an open set voltage of 1 V. Also, 4192A produced by YHP was used as measurement equipment. Inductance was obtained at each of the frequencies of 10 kHz, 100 kHz, and 1 MHz. Also, magnetic permeability was measured from the inductance value.

The results thereof are shown in Tables 3 to 5.

TABLE 3

| | Magnetic core | |
|---|---|---|
| | Crystallinity | Average crystal |
| | degree | grain size (nm) |
| Example 1 | 0.95 | 10 |
| Example 2 | 0.96 | 12 |
| Example 3 | 0.95 | 11 |
| Example 4 | 0.94 | 15 |
| Example 5 | 0.94 | 13 |
| Comparative example 1 | 0.92 | 25 |
| Comparative example 2 | 0.90 | 11 |
| Reference example 1 | 0.93 | 12 |

TABLE 4

| | Magnetic core | | | | |
|---|---|---|---|---|---|
| | Inductance | | | | |
| | L₁₀ (μH) | L₁₀₀ (μH) | L_{1M} (μH) | L₁₀/L₁₀₀ | L₁₀₀/L_{1M} |
| Example 1 | 41.1 | 29.5 | 3.6 | 1.39 | 8.21 |
| Example 2 | 31.1 | 25.4 | 3.1 | 1.23 | 8.27 |
| Example 3 | 24.6 | 18.4 | 2.4 | 1.34 | 7.73 |
| Example 4 | 27.2 | 19.3 | 2.2 | 1.41 | 8.96 |
| Example 5 | 38.9 | 26.8 | 2.8 | 1.45 | 9.46 |
| Comparative | 26.4 | 23.4 | 1.9 | 1.13 | 12.34 |
| example 1 | | | | | |
| Comparative | 89.0 | 25.3 | 2.4 | 3.52 | 10.60 |
| example 2 | | | | | |
| Reference | 13.9 | 13.1 | 2.3 | 1.06 | 5.63 |
| example 1 | | | | | |

TABLE 5

| | Magnetic permeability μ of | | |
|---|---|---|---|
| | magnetic core | | |
| | 10 kHz | 100 kHz | 1 MHz |
| Example 1 | 39,123 | 28,105 | 3,423 |
| Example 2 | 28,512 | 23,243 | 2,811 |
| Example 3 | 22,845 | 17,087 | 2,210 |
| Example 4 | 24,326 | 17,197 | 1,920 |
| Example 5 | 34,265 | 23,674 | 2,503 |
| Comparative example 1 | 25,144 | 22,324 | 1,809 |
| Comparative example 2 | 82,514 | 23,465 | 2,213 |
| Reference example 1 | 13,265 | 12,520 | 2,224 |

As is understood from Tables 3 to 5, the changes caused by the frequencies of inductance and magnetic permeability are suppressed in the magnetic cores according to Examples. Therefore, excellent properties are exhibited as the magnetic cores used in the region of 10 kHz or higher and 1 MHz or lower.

Hereinabove, some embodiments of the present invention have been shown as examples. However, these embodiments were presented as examples, but are not intended to limit the scope of the invention. These novel embodiments can be carried out in other various modes, and various omittance, replacement, changes, etc. can be made within the range not departing from the gist of the invention. These embodiments and modification examples thereof are included in the scope and gist of the invention and are also included in the invention described in claims and equivalent scopes thereof. The above described embodiments can be mutually combined and carried out.

1. A magnetic ribbon having a crystallinity degree of 0.05 or higher and 0.4 or lower when the magnetic ribbon is subjected to XRD analysis, the magnetic ribbon being Fe—Nb—Cu—Si—B-base, and the crystallinity degree being expressed by “a peak total area of a crystalline phase”/(“a peak area of an amorphous phase”+“the peak total area of the crystalline phase”).

2. The magnetic ribbon according to claim 1 having a region in which a KIKUCHI pattern is detected when the crystalline phase is subjected to EBSD analysis.

3. The magnetic ribbon according to claim 1, wherein the magnetic ribbon has a sheet thickness of 25 μm or lower.

4. A magnetic core comprising the magnetic ribbon according to claim 1 wound or stacked.

5. The magnetic core comprising a crystalline structure having an average crystal grain size of 200 nm or lower obtained by subjecting the magnetic core according to claim 4 to heat treatment.

6. The magnetic core according to claim 4 having a value of a crystallinity degree of 0.9 or higher when the magnetic core is subjected to XRD analysis.

7. The magnetic core according to claim 4 comprising a wound coil.

8. The magnetic core according to claim 4 having L₁₀/L₁₀₀ of 1.5 or lower and a magnetic permeability at 100 kHz of 15000 or higher, wherein inductance at 10 kHz is L₁₀, and inductance at 100 kHz is L₁₀₀.

9. The magnetic core according to claim 4 having L₁₀₀/L_{1M} of 11 or lower and a magnetic permeability at 100 kHz of 15000 or higher, wherein inductance at 100 kHz is L₁₀₀, and inductance at 1 MHz is Lim.

10. A magnetic core comprising the magnetic ribbon according to claim 3 wound or stacked, wherein
the magnetic core
comprises a crystalline structure having an average crystal grain size of 200 nm or lower obtained by subjecting the magnetic core to heat treatment,
has a value of a crystallinity degree of 0.9 or higher when the magnetic core is subjected to XRD analysis, and
has L₁₀/L₁₀₀ of 1.5 or lower and a magnetic permeability at 100 kHz of 15000 or higher, wherein inductance at 10 kHz is L₁₀, and inductance at 100 kHz is L₁₀₀.

11. A magnetic core comprising the magnetic ribbon according to claim 3 wound or stacked, wherein
the magnetic core
comprises a crystalline structure having an average crystal grain size of 200 nm or lower obtained by subjecting the magnetic core to heat treatment,
has a value of a crystallinity degree of 0.9 or higher when the magnetic core is subjected to XRD analysis, and
has L₁₀₀/L_{1M} of 11 or lower and a magnetic permeability at 100 kHz of 15000 or higher, wherein inductance at 100 kH is Lim, and inductance at 1 MHz is L_{1M}.
